(19) United States
(12) Patent Application Publication
(10) Pub. No.: US 2009/0189754 A1
(43) Pub. Date: Jul. 30, 2009

(54) VEHICLE IMPACT WARNING DEVICE

(76) Inventor: Hans Edmund Hochrein, Klingenberg-Trennfurt (DE)

Correspondence Address: EDWIN D. SCHINDLER, FIVE HIRSCH AVENUE, P.O. BOX 966, CORAM, NY, 11727-0966, US

(21) Appl. No.: 12/297,850

(22) PCT Filed: Apr. 13, 2007
(86) PCT No.: PCT/DE07/00650

§ 371 Date: Jan. 30, 2009

(30) Foreign Application Priority Data
Apr. 20, 2006 (DE) 10 2006 018 723.7

(51) Int. Cl. B60Q 1/00

(52) U.S. Cl. 340/436

(57) ABSTRACT

A vehicle impact warning apparatus for installation in a motor vehicle includes a deceleration sensor, for detecting vehicle decelerations in a direction approximately parallel to a carriageway, and a switch that can be activated by the deceleration sensor. The switch, by way of a radio transmitter, is able to initiate an electromagnetic warning signal and a warning signal as a visible warning signal and/or as an acoustic warning signal.

The invention relates to a vehicle impact warning device for installation in a motor vehicle, comprising a deceleration sensor, by means of which decelerations in a direction approximately parallel to the roadway can be detected and a switch that can be activated by the deceleration sensor.

In road traffic, there are numerous accidents purely as a result of an accident that has taken place shortly beforehand. The primary cause of the accident is the lack of information of the following road users about the fact of the accident, which took place in the direct vicinity immediately before them without them having received this information promptly. In the progress of these so-called “secondary accidents” a particularly typical and frequent behaviour pattern is that a drive assumes that the motor vehicles driving immediately ahead of him will also continue to move forward at uniform speed in the near and immediate future as they have done before. The driver extrapolates the experience of a uniform and continuous traffic flow onto the behaviour of the road user driving ahead of him, and, correspondingly, is often driving with too little attention and/or too little distance and/or too high speed.

If, in this situation, an accident occurs, which suddenly blocks the road, the reaction time for the subsequent car drivers is, in many cases, too long and/or the available stopping distance to the next road user in the direction of travel and/or the own road speed is too high in proportion to these boundary conditions. In such as situation, numerous so-called “rear-end collisions” occur. These rear-end collision not only cause severe damage to the vehicles involved and their drivers and passengers, but can also be life-threatening. Another form damage that can also be concretely ascertained in its effect is the time loss for all road users as a result of reduced driving speed and/or waiting pauses. In addition, there are the emotional stresses caused by unplanned delay and waiting time, and or the sight of the accident spot.

For this reason, major accidents, after they have become known, are recorded by the responsible institutions and according to the prior art by the broadcasting bodies, and broadcast at regular intervals and as an appropriately coded diversion recommendation to the navigation systems set up for this purpose. In addition, at a certain distance from the scene of the accident, warning facilities are set up and/or police officers posted to warn the subsequent travellers.

The accident information stored in this way can furthermore be called up by suitable radio receivers as a speech signal and/or by navigation units set up for this purpose as text information on a display.

The serious disadvantage of these information systems, however, is the acute time delay between the occurrence of the accident and the notification of the following car drivers. Those car drivers are particularly seriously disadvantaged who are not following the accident vehicle at a distance close enough for them to follow the progress of the accident by their own observation, but are driving at a distance far enough to be prevented—as a result of other vehicles and/or road curves and vegetation, terrain elevations or buildings—from directly following the course of the accident, but at a distance short enough that—as a result of the delayed reactions of the car drivers in front of them (reaction times) and the sudden braking necessitated by the insufficient distances between the vehicles—they in turn must perform vigorous braking and in many cases emergency braking, and in some cases, after they have recognised the need for a sudden deceleration, realize that there is no longer enough distance on the road for this.

Another disadvantage of the accident information via broadcast announcements is that, because of the great time delay, it does not offer willing drivers and passengers the opportunity to help after the accident.

Another serious weakness of the accident information systems of the prior art is that at least one purely manually operated stage of information input and information transfer is incorporated into the information chain.

According to the prior art that is most frequently used, the only method used is surveillance cameras mounted at large areas with continual monitoring of the images transmitted to a central station in order to initiate an accident alarm as quickly as possible.

What are hitherto not known are accident reports initiated directly by the vehicle.

Against this background, it is the object of the invention to provide a device that is installed in the motor vehicle and registers the occurrence of an impact at the earliest possible point in time and warns all the other vehicles travelling in the same direction with an adjustable maximum distance behind the vehicle that has experienced the accident. Distances of the order of some kilometres are intended, so that the vehicle that has experienced the accident is outside the visible or audible range. It should also be possible to transmit the warning if a line of sight is restricted or interrupted as a result of darkness, rain, snow, fog or other inclement weather conditions.

However, it should also be possible to emit the warning optically and acoustically.

In a further stage of development, the device should transmit a received warning automatically to another similar device.

Through a simple construction, with known components, it should be possible to achieve a low price and high reliability, and therefore very widespread adoption.

As a solution, the invention proposes a vehicle impact warning device that consists of a deceleration sensor and a switch, which is activatable by said sensor, which is characterised in that a first electromagnetic radio warning signal and a warning signal in the form of a visible warning signal and/or an acoustic warning signal can be transmitted via a radio transmitter.

These functions can be realised inexpensively and reliably based of components available in the prior art by means of a simply constructed electronic unit. All the deceleration sensors that are currently conventionally used consist of a moving mass, which, by virtue of its inertia with respect to the housing of the sensor, moves somewhat in the event of a crash, this movement counteracting a continuously increasing force, which is usually applied by means of a mechanical spring.

Also known are variants in which a ball is held in a particular position by a magnetic field, and is moved out of the zero point through a particular distance in proportion to the deceleration.

All designs of deceleration sensors usually cover a threshold value of the order of 3 to 5 g. The reporting of the exceeding of this threshold value is initiated by the fact that either the mass produces contact or that the mass changes an electrical capacitance or inductance, which is evaluated by means of an electronic circuit suitable for this purpose.

All crash sensors are designed such that, on reaching a threshold value, they activate an electrical contact, either directly or via a power semiconductor device, by means of which further consumers can be connected. This switch can be designed as an electronic circuit, that is to say as a second, larger power semiconductor. However, all conventional forms of relay are also possible.

As soon as the preset acceleration limit has been exceeded by the deceleration sensor, the circuit closes and thereby activates both a warning signal and a radio transmitter. As warning signal, visible warning signals are possible, that is to say all signals that are visible on the motor vehicle, effect an optical change and/or acoustic signals, that is to say all forms of sound or sound changes that are audible by other road users.

In the simplest variant, a vehicle impact warning device according to the invention serves to emit a warning signal from a vehicle that has experienced an accident, which is acoustically or optically perceptible, and also to additionally emit a radio signal. The first group of warning signals permits all persons that are in the visible or audible range of the vehicle that has experienced the accident firstly to notice that an accident has occurred at all and secondly to immediately locate the place of the accident, and therefore from a relatively large distance to rapidly and reliably identify which of several vehicles has experienced an accident.

The vehicle impact warning device is suitable for all kinds of vehicle, e.g. for personal cars, commercial vehicles, omnibuses, mobile homes, tractors, construction vehicles, agricultural vehicles, military vehicles, and also for motorcycles, which in principle are more safety critical. Since the risk of personal injury is higher in the case of motorcycles than for vehicles with closed superstructures, the calling of help by the vehicle impact warning device is a particularly important advantage of the invention. It is also appropriate to use the invention for high-speed water craft, such as motor boats on highly frequented waterways.

In this simplest design, all road users within visible and audible range are clearly notified that the relevant vehicle has experienced an accident. An advantage is that the information is transmitted even after the impact. Another advantage is that the accident is also identifiable for those who have neither nor heard seen the accident themselves, or only heard it but not seen it.

This function can also be valuable for other vehicles following directly behind the vehicle that has experienced the accident, since an impact with the front of a vehicle is possible that is not readily recognizable and/or noticeable from the rear side.

In addition, the vehicle that has experienced the accident “reports” by the activation of a radio signal. In the simplest case, that is a single electromagnetic wave, which is continually emitted. The transmission module required for this is, according to the state of the art, available at low prices and, correspondingly, also available in a model as a safety device with increased requirements on the operating temperature range, corrosion resistance and shock sensitivity, at costs that are hardly significant in comparison to the total price of a motor vehicle.

Registration of such a simple accident report is always the responsibility of those institutions that already register accident reports manually in the prior art. They are the accident desks of the police, fire services and other public disaster control organisations.

It is also conceivable, however, for private institutions, which supply a vehicle impact warning device as vehicle equipment, to offer a stationary infrastructure necessary for its evaluation, such as radio receivers and the facilities for identifying the accident location, and at least the initiation of, and, as a further measure, the performance of assistance and rescue services.

An advantage of the vehicle impact warning device is its small dimensions. A prototype, which is equipped with a loudspeaker, a volume control, a warning switch, a signal lamp, and a key-operated switch, is mounted in a housing of about 115 mm length, 35 mm height and 60 mm width, and weighs only 250 grams.

For this functionality, it is appropriate to extend the vehicle impact warning device, in a further development stage, such that it automatically transmits its current site to the supervisory rescue organization. For this purpose, in the prior art it requires the reception and evaluation of GPS (global positioning system) signals. Devices, which are customarily available at low cost, receive the signals of three geostationary satellites, and from them calculate the coordinates of the position, and transmit them to the radio transmitters, which immediately retransmits them together with the radio warning signal. This information is used to inform the appropriate control center that an accident has taken place, but also at what location.

This information can be expanded in various stages. It is relatively easy to obtain the signals of a so-called seat detector. It provides information about how many persons are occupying the seats of the vehicle that has experienced the accident.

If, in a further variant, the number of occupied seats is registered before and after the accident, then seats that are no longer occupied, or apparently additionally occupied, after the accident can be used to conclude that the position of the vehicle occupants has changed as a result of the accident, and/or that additional objects have landed on the seats, which permits a rough estimation of the accident severity.

As further information, it is conceivable to record the deceleration value, since further damage to the vehicle and its passengers occurs in proportion to the peak value of the deceleration.

In the next stage of development it is conceivable to register other crash sensors that may be additionally present in the vehicle. It could be transmitted, for example how many and which airbags have responded, and whether there are sensors on the vehicle itself that have registered higher peak accelerations than other sensors, that is to say signal a particularly heavily damaged region of the vehicle.

Likewise the evaluation of the sensors of the electronic stabilization program (ESP) is conceivable, in order thereby to transmit the position of the vehicle after the accident, i.e. to signal a possible turning over or tipping over of the vehicle to the central station.

As additional equipment, it is conceivable that the vehicle impact warning device activates a mobile telephone present in the vehicle and dials a number provided for this accident. Thereby, alternatively to the GPS, it is possible to register the site of the vehicle that has experienced the accident and, with appropriate equipment, also to produce a speech link between the relevant accident center and the vehicle occupants.

Alternatively, the transmission unit of a mobile phone can be installed in the vehicle impact warning device. After dialling a special emergency number in an emergency, its function can be restricted to transmitting a standardised accident report. This accident report serves to register the accident and indirectly for determining the accident location by localizing the mobile transmission unit by at least two receiving stations. This saves the incorporation of an additional GPS system.

All the above-described functions of the radio transmitter can be distinguished, particularly reliably and without interference, from other radio signals, if a particular frequency is made available for this. The invention proposes the frequency of 433.92 MHz or 868 MHz for this.

In a simple embodiment, it is also suitable to upgrade the vehicle impact warning device into a mobile emergency call system by means of a manually operable key. In this way, by appropriate design of the actuating element, it should be possible to prevent accidental or mischievous actuation by children. It would be possible, for example, to enter a particular number sequence or actuate two devices simultaneously.

An alternative is a safety locks with a removable key.

As another significant function, the object of the invention is to directly warn other vehicles, in particular following vehicles. To this end, the vehicle proposes extending the vehicle impact warning device with a radio receiver, which is provided for receiving a radio warning signal from the radio transmitter of another vehicle that has experienced an accident. This opens up the possibility of the vehicle that has experienced an accident transmitting its warning directly to the road users behind, beyond the limits of the visible and/or audible and without going via a centralised accident reporting center, and without the resulting delay. Since the criterion of exceeding an acceleration threshold is a clear feature of the occurrence of an accident, the direct and unfiltered transmission to other road users is appropriate and useful, unlike a manual accident report.

Since the singles emitted by a vehicle in an emergency situation in the prior art are limited to the brake light, and the warning indicators of most vehicles must be manually switched on, such an accident signal, which is emitted in real time in comparison to the process of the accident, is advantageous in the seconds and fractions of a second following an impact, particularly in cases in which an impact that has already occurred behind a vehicle is not recognizable directly but only indirectly, e.g. as a result of vehicle parts falling off or flying away, since all these features are secondary and only occur with a time delay. In comparison to this, the impact report by a radio signal takes place so rapidly that the following driver may still have time to avert, or at least reduce the severity of, an impact.

Since the report of an accident is only of marginal importance for vehicles ahead of the one affected, but is of vital importance for following vehicles, the invention proposes emitting the signal from the radio transmitter preferentially only in the direction of the reverse side of the vehicle.

An additional switch on the unit may be provided for activating this limitation. Alternatively, a speed-dependent activation is also conceivable.

For the same reason, the additional radio receiver should also preferentially receive signals arriving from the front of the vehicle as seen in the direction of travel. By this means, the propagation of accident reports to vehicle impact warning devices that are not actually affected is greatly restricted.

To make the radio warning signals received by a radio receiver noticeable to the driver, a warning signal in the form of a visible warning signal and/or an acoustic warning signal must also be initiated. To this end, it is conceivable, for notification of the driver, to illuminate a light on the vehicle impact warning device itself, a warning light on the dashboard and/or a display within the driver's visible range. In addition, it is appropriate, in this case, too, to activate the warning indicator of the vehicle and its brake lights, so that a warning is also given to other road users whose vehicle does not have a suitable radio receiver.

With the activation of the warning indicator, the control lamp provided for this purpose in the driver's visible range is also activated, and consequently the visible warning signal the vehicle impact warning device is unnecessary.

Alternatively or additionally to the visible warning signal the vehicle impact warning device according to the invention may also initiate acoustic warning signals. This includes the vehicle horn and/or the silencing of all loudspeakers of audio systems within the vehicle.

As a further alternative, these loudspeakers can be used for emitting an audible signal, insofar as the vehicle impact warning device does not have its own loudspeaker and/or its own, other sound generation unit.

As audible signal, sounds are conceivable that either sound uniformly or are variable in volume or pitch. In the simplest alternative, a single tone is sufficient. It is also conceivable to use multi-tone signals. A possible alternative, for example, is to imitate the sound of a Martin horn, reserved for emergencies, that is to say the regular alternation of two tones whose frequencies differ by one musical fourth as defined in DIN 14610, or the sound of a siren. In addition, a blue light may flash in the driver's visible range.

Since the accident report is of particular high importance for the directly following vehicles, but reduces in importance with increasing distance from the vehicle that has experienced the accident, it is appropriate to reduce the range of the radio signal. The most proven and easiest way to limit the range is to limit the transmission power. Although, for a given power, the range fluctuates depending on the local reflections and depending on the media that the radio signals must penetrate, the effort for reducing the power is comparatively small and also enables costs to be reduced, especially through the choice of smallest possible components.

To be able to warn vehicles at a larger distance from the vehicle that has experienced the accident with small-powered transmitters, such as is appropriate on freeways and high-speed roads, the invention proposes that, with the reception of a first radio warning signal by a vehicle impact warning device, a second radio warning signal can be transmitted in a second reaction stage.

For this, the invention recommends that the second radio warning signal can be recognized as a second signal by all radio receivers by means of additional information. Since, in practice, the signals are principally emitted rearwards and preferentially received from the front, the identification as a second signal transmits the information that, although the accident has taken place close to the receiver, in these circumstances the primary radio signal cannot be received, but only a secondary signal, and so the distance from the point of the accident must be at least as far as the average range of the transmitter, but not greater than twice the range of the transmitter.

In a continuation of this idea, with the reception of a second radio warning signal, the radio transmitter emits a third warning signal, so that the information chain extends to vehicles opposite to the direction of travel to vehicles approaching the site of the accident. The length of this chain should be reduced to a sensible degree, that is to say that, after the reception of a particular number of accident reports have been transmitted to following vehicles in a cascade, no further accident signal is transmitted.

It is conceivable that, from the number of radio warning signals transmitted in a cascade, and the average range, a rough value for the distance to the accident can be calculated and displayed to the driver.

In a further advantageous development, the radio receiver can receive further additional radio information signals, which should be used principally for information that is relevant to road users located behind a vehicle that has experienced an accident. Typical examples are instructions such as “clear a path!” or “drive on the right verge!” or “accident ahead.” It is also conceivable to transmit requests such as “doctor needed!” or “voluntary helpers needed”

To install a vehicle impact warning device according to the invention, the invention proposes mounting of the device on the parcel shelf below the rear window or on the dashboard. The advantages of these positions are that radio signals can be transmitted and received unhindered through the glass panes of the vehicle. A further advantage is that it is found that this part of vehicles is the last to be damaged, so that the vehicle impact warning device is still undamaged even after severe accidents. Alternatively, the device can also be mounted on the boot roof or on the vehicle roof.

Also conceivable are all other places in the vehicle that are suitable for the installation of electronic devices, in so far as an antenna that can transmit and receive unhindered is provided.

It is, of course, also conceivable to evaluate the crash sensors that are already installed as standard in numerous vehicles via the existing electrical circuit of the vehicle such that they initiate the visible and acoustic warning signals according to the invention on the vehicle. In this configuration, only an additional transmission and receiving unit would have to be added. Although in the prior art, e.g. for mobile telephony, on-board transmitters and receivers are provided in numerous vehicles, they have the disadvantage of only restricted availability, and it is therefore a special merit of the invention to require a separate frequency and a separate device for this purpose in the interest of maximum reliability.

The development of a vehicle impact warning device according to the invention as a separate module results in greater redundancy of the vehicle impact warning device, and therefore also increased probability of the availability of a warning in the even of serious and extremely serious accidents.

The configuration as an independent module, which is used in various vehicles by various manufactures as a standardized component, offers the opportunity for production in very large quantities with increased insensitivity to extreme operating temperatures at down to −20° C. and up to +70° C., to extreme decelerations above the response threshold of 3 to 5 g, and to environmental influences, in particular moisture to permanent thawing and immersion in water in an accident. In an advantageous configuration, a vehicle impact warning device according to the invention is to be equipped with a rechargeable battery, which is regularly recharged by the on-board electrical system in normal operation of the vehicle and, in an emergency in the event of a failure of the on-board electrical system, still performs the minimum functions of a vehicle impact warning device. That includes—in this priority—the transmission of a radio warning signal, closing a relay or other working contact and outputting a warning signal. With the relay, after the accident, those warning devices are activated that still have access to an operating energy supply.

In the case that the electrical on-board electrical system of the vehicle fails completely in an accident, the invention proposes that the device itself has acoustic warning alarms, such as a loudspeaker and/or in particular elements with a very good efficiency, such as a piezo alarm sounder and/or highly efficient illuminating elements, such as LEDs (light-emitting diodes).

For the practical implementation of a vehicle impact warning device according to the invention, the invention prefers, for maximum availability, a construction that is autonomous as possible. However, it is also conceivable to integrate it into other electronic modules found in motor vehicles, such as players for recorded media, or in broadcast radio receivers, television receivers or navigation equipment. In these cases, it would be economically advantageous to use their radio receivers as well.

It would also be conceivable and economically advantageous to integrate it into electronic modules that also need to transmit, such as road-use control equipment, radio telephones or navigation equipment that continually accesses external data sources.

It is also possible and appropriate to install a vehicle impact warning device according to the invention in a stationary emergency telephone station. Activation of the emergency telephone not only emits an alarm to vehicles in the immediate vicinity, but also emits an accident warning to the highway maintenance department or another institution, which receives the emergency call.

As another advantageous embodiment, a vehicle impact warning device can be extended with the function of an accident data storage device. It is particularly interesting to store kinematic and acoustic data of the vehicle involved in the accident from the triggering of the deceleration sensor, and, in a further expansion stage, even from a particular time span directly before the accident event. This combination is particularly attractive because the vehicle impact warning device is an especially insensitive and robust module, which is preferably mounted at a comparatively secure mounting point.

The invention proposes that the radio warning signals, the visible warning signals and the acoustic warning signals are only emitted for a limited, adjustable time, for example 5 to 10 minutes. The advantage of this restriction is that the load on the frequency range reserved for emergencies is kept to a minimum and that the interference with other unconcerned road users and residents, particularly by the acoustic warning signal, is kept to a necessary minimum.

As another advantageous embodiment, the invention proposes that the vehicle impact warning device can emit at least three different acoustic warning signals. Here, it is appropriate that the acoustic warning signal with the greatest volume can be initiated by deceleration sensors directly and without the possibility of manual interruptions, thereby, the possibility of manipulation for misuse of the warning device is greatly reduced and the operating reliability is increased, since as few parts as possible are involved.

Another advantageous variant is that the warning signal also includes a speech signal. This includes numerous possibilities for more differentiated information about the reported event. Since modern vehicles are already very widely equipped with warning tones, a speech report, e.g. with the word “attention” makes a very suitable distinction. Such a small language base can be easily converted into the German word “Achtung, the French word “attention” or the Italian word “attentione”.

A further feature greatly increasing the practical utility are warning keys, which when operated send out an additional speech signal, for “obstruction on the carriageway” and/or “stationary vehicle” and/or “animals on the carriageway” and/or “wrong-way driver” and/or another specific hazard situation. By this means, it is possible to transmit unfortunately very frequently occurring hazard situations promptly to affected car drivers in the close vicinity. An alternative method for conveying this information in the receiving vehicle, besides the speech message, is the illumination of a text or a pictogram, which can also act as an actuating key for transmitting this information oneself.

If the vehicle impact warning device is equipped such that it also transmits and/or receives on radio frequencies, which are provided for regionally relevant institutions for use by the road emergency services or even exclusively reserved, the additional use as receivers for information and/or instructions to these institutions. It is also conceivable that, e.g. the vehicle impact warning device receives commands from the approved transmitters and the authorized institutions, which can then be transmitted as a pictogram and/or presented on a display and/or as speech signals. Examples include: “clear a path!” and/or “drive at the right!” or “stop!” and/or “turn around!” and/or “ambulance” and/or “police” and/or “customs” and/or “fire service” and/or “emergency vehicle”.

As already mentioned such a frequency can also be used for activating a warning tone in the interior of the vehicle similar to the sound of a Martin horn, that is to say a tone-sequence as described in, e.g. DIN 14610. In addition to this acoustic signal, a blue light can flash on the dashboard or in the driver's visible range, as a result of which not only the attention value can be increased, but also the legal requirement, e.g., for Germany is fulfilled that the emergency vehicle only has unrestricted precedence if a blue flashing light and Martin horn are activated simultaneously.

A particularly valuable optional extra is a vehicle impact warning device according to the invention in the same form for motorcycles. Since numerous motorcycle drivers received their injuries after an accident because they have been removed from the carriageway by the accident to the extent that their vehicle was no longer visible from the carriageway, so that the urgently required help could no longer be provided promptly, a vehicle impact warning device according to the invention for a motorcycle is not only an important source of information for following road users, but also a very valuable message for help, giving an urgent request for first aid.

For a vehicle impact warning device can be functionally mounted on a motorcycle, the invention proposes as a variant that the vehicle impact warning device is installed in a housing that has two mutually parallel elongated strips on one outside, and via these strips can be clamped on at least one metal fastener or a rail that is oriented transversely to the strips. By means of the two parallel strips, the housing can be mounted on a tube of the motorcycle frame, and clamped on the frame tube at the other side by means of the metal fastener. By this means, retro-fitting with the mechanical strength required for the impact sensor is possible.

For permanent availability, this housing should be protected against water jets or splashes.

Alternatively, the metal fastener can be designed as a quick-action fastener, so that a vehicle impact warning device can be used alternately in several vehicles. For example, the motorcyclist can also use his vehicle impact warning device in his car.

To avoid false reports from parking jolts and gusts of wind, it is appropriate to only report from the crash sensor is only given from a minimum speed. The invention proposes as an appropriate value for a minimum speed, a range from about 55 km/h.

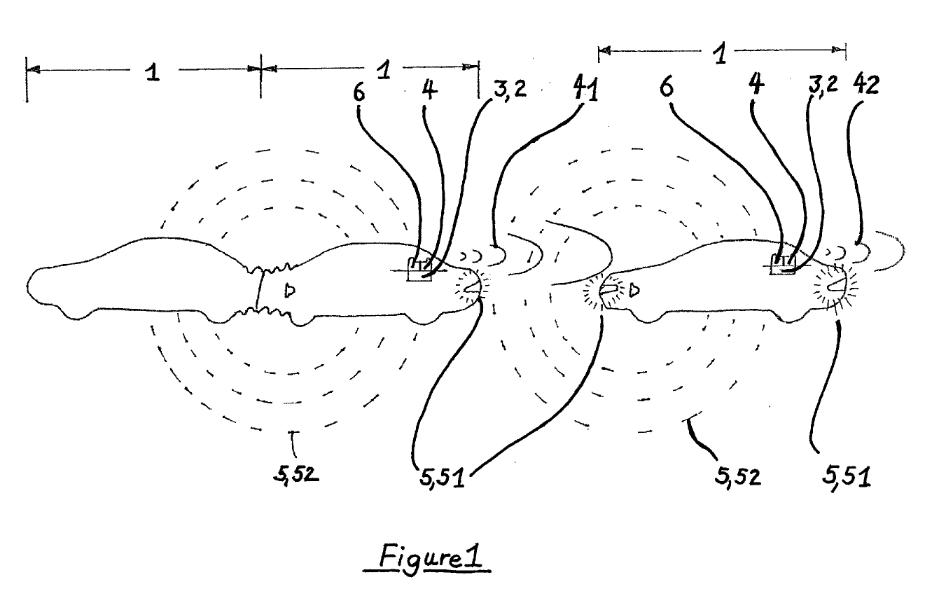

Further details and features of the invention are explained below in greater detail with reference to examples. However, they are not intended to limit the invention but only explain it. FIG. 1 shows schematically the principle of a rear-end collision and the transmission of warning signals.

FIG. 1 shows a total of three motor vehicles 1 in side view as outline diagrams. Of these three motor vehicles 1, a second motor vehicle 2 has crashed into the first motor vehicle 1, recognizable by the deformations in the tail of the first motor vehicle and the crumpling in the front part of the second motor vehicle 1.

In the second and third motor vehicles 1, a vehicle impact warning device is shown diagrammatically in the region of the parcel shelf in each case. In the lower part it consists of the switch 3 with the triggering deceleration sensor 2. Also integrated in the vehicle impact warning device assembly is the radio transmitter 4, which, on an impact, transmits a first radio warning signal 41 predominantly in the direction opposite to the travel direction of the vehicles. As a result, it meets the following motor vehicle 1 and reaches the radio sensor 6, which activates the switch 3, and thereby then initiates a second radio warning signal 42, which is received by further vehicles in the vicinity.

Because, the switch 3 is active in the center motor vehicle 1, which has experienced the accident, as well as in the following, third vehicle 1, a visible warning signal 51 is initiated, the warning flashing light of the vehicle in the example in the drawing. It is also conceivable, to activate the brake lights, the tail lights, the driving lights or the side lights.

An acoustic warning signal 52 is additionally activated, which is emitted, e.g., by the horn.

In FIG. 1, it can be seen how the vehicle that has experienced the accident emits a first radio warning signal 41, which is received in the subsequent motor vehicle 1, and there initiates a second radio warning signal 41, which in turn is also emitted rearwards. As a result, multiple vehicles can be linked in a cascade-like chain of warning messages, which, despite a limited range of the radio transmitters 4 nevertheless permits the early warning of a large number of following road users over a distance that is several times further than the range of a single vehicle impact warning device.

### LIST OF REFERENCE CHARACTERS

1 Motor vehicle

2 Deceleration sensor installed in a motor vehicle 1

3 Switch, triggerable by deceleration sensor 1

4 Radio transmitter triggerable by switch 3

41 First radio warning signal, transmitted by radio transmitter 4 on the crash of the first motor vehicle

42 Second radio warning signal, transmitted by the second radio transmitter 4 in a second motor vehicle after reception of the first radio warning signal 41

5 Warning signal either as a visible warning signal 51 and/or as an acoustic warning signal 52

51 Visible warning signal initiated by the deceleration sensor 2 via switch 3

52 Acoustic warning signal initiated by the deceleration sensor 2 via switch 3

6 Radio receiver for receiving the radio warning signals 41 and/or 42

1-47. (canceled)

48. A vehicle impact warning apparatus for installation in a motor vehicle, comprising:
a deceleration sensor for sensing a deceleration in a direction approximately parallel to a roadway; and,
a switch capable of being activated by said deceleration sensor, said switch including means for initiating a first warning signal via a radio transmitter, said first warning signal being an electromagnetic radio warning signal, and a second warning signal being at least one of a visible warning signal and an acoustic warning signal.

49. The vehicle impact warning apparatus for installation in a motor vehicle according to claim 48, wherein said radio transmitter for transmitting said first warning signal only emits said first warning signal in a limited angle at a reverse side, as seen in a travel direction, of an impacting motor vehicle.

50. The vehicle impact warning apparatus for installation in a motor vehicle according to claim 48, wherein said acoustic warning signal includes at least three different acoustic warnings.

51. The vehicle impact warning apparatus for installation in a motor vehicle according to claim 50, wherein said at least three different acoustic warnings includes one different acoustic warning having a volume that is greater than any of said at least three different acoustic warnings and can be initiated free of manual interruption by said deceleration sensor.

52. The vehicle impact warning apparatus for installation in a motor vehicle according to claim 48, wherein said acoustic warning signal includes at least one acoustic warning that is a uniform tone, a tone having a variable sound and a tone having a variable pitch.

53. The vehicle impact warning apparatus for installation in a motor vehicle according to claim 48, wherein said second warning signal includes a speech signal.

54. The vehicle impact warning apparatus for installation in a motor vehicle according to claim 48, further comprising:
means for receiving electromagnetic signals that are convertible into optical signals; and,
means for converting said optical signals received by said means for receiving electromagnetic signals into said optical signals.

55. The vehicle impact warning apparatus for installation in a motor vehicle according to claim 48, further comprising:
means for receiving electromagnetic signals that are convertible into acoustic signals; and,
means for converting said acoustic signals received by said means for receiving electromagnetic signals into said acoustic signals.

56. The vehicle impact warning apparatus for installation in a motor vehicle according to claim 55, further comprising means for suppressing all said acoustic signals received except for one acoustic signal of said acoustic signals.

57. The vehicle impact warning apparatus for installation in a motor vehicle according to claim 48, wherein said radio transmitter has a transmission power that is limited to a predetermined threshold value.

58. The vehicle impact warning apparatus for installation in a motor vehicle according to claim 48, wherein upon reception of said first warning signal by a radio receiver, an additional warning signal, or third warning signal, is transmittable in a time-delayed reaction stage.

59. The vehicle impact warning apparatus for installation in a motor vehicle according to claim 58, wherein said additional warning signal is transmittable via a radio receiver that is propagated in a cascade across a plurality of motor vehicle impact warning apparatuses in a plurality of reaction stages.

60. The vehicle impact warning apparatus for installation in a motor vehicle according to claim 48, further comprising:
means for registering a real-time speed of a motor vehicle; and,
means for remitting a warning signal when the real-time speed of the motor vehicle exceeds a predetermined minimum speed value.

62. The vehicle impact warning apparatus for installation in a motor vehicle according to claim 48, further comprising:
means for detecting that the motor vehicle has been in an accident; and,
means for dialing an emergency telephone number when said means for detecting that the motor vehicle has been in an accident detects the occurrence of an accident.
